(19) United States
(12) Patent Application Publication
(10) Pub. No.: US 2016/0136825 A1
(43) Pub. Date: May 19, 2016

(54) MULTI-LOCKING UTILITY CUTTER

(71) Applicant: SDI CORPORATION, Chang Hua (TW)

(72) Inventor: Chih-Wei HSU, CHANG HUA (TW)

(73) Assignee: SDI CORPORATION, Chang Hua (TW)

(21) Appl. No.: 14/540,808

(22) Filed: Nov. 13, 2014

(51) Int. Cl. B26B 5/00

(52) U.S. Cl. CPC B26B 5/002

(57) ABSTRACT

A multi-locking utility cutter has a shank, a blade and a slider. The shank has a guiding groove having multiple first locking units. The blade is slidably mounted in the shank and selectively covers the first locking units. The slider is connected with the blade and has a second locking unit. When no external force is applied on the slider, the first locking unit and the second locking unit are engaged with each other to provide a locking effect to the blade. When the slider is forced, the second locking unit is disengaged from the first locking unit, such that the blade can slide. A locking position between the first locking unit and the second locking unit is located at the guiding groove of the shank, such that a locking force can be uniformly distributed on the guiding groove of the shank. Therefore, the guiding groove can be forced uniformly and the locking effect can be increased and improved. Further, the first locking units are covered and avoid exposure to the exterior environment to prevent damage.

### BACKGROUND OF THE INVENTION

1. Field of the Invention

The present invention relates to a multi-locking utility cutter, and more particularly to a utility cutter that is applied to cut items and has a locking effect for positioning a blade of the multi-locking utility cutter.

2. Description of Related Art

A utility cutter having a retractable blade is a common hand tool. The blade is slidably mounted in a shank of the utility cutter to adjust a length of the blade extended out of an end of the shank for use. When not in use, the blade can be fully retracted in the shank to keep a user from being accidentally cut by the blade. However, when the blade is extended out of the shank for use, if the blade is forced and changed to retract into the shank automatically, it is difficult for the user to apply his or her force on the utility cutter when cutting an item. Therefore, the accuracy and the efficiency of cutting the items may be affected. On the other hand, while the blade is retracted into the shank, the blade may inadvertently slide out of the shank and damage other items or injure the user. Therefore, to prevent the blade from being retracted or extended relative to the shank inadvertently, the utility cutter has a locking device to lock the blade extended out of the shank at a desired extension length, such that it is convenient for the user to operate the utility cutter.

With reference to FIG. 12, a conventional utility cutter has a shank 60 with a guiding groove, wherein a blade 70 is mounted in the guiding groove of the shank 60. The guiding groove has multiple engagement teeth 61 protruding on a side of the guiding groove. A slider 80 is connected with the blade 70 and cooperates with the engagement teeth 61, such that when the blade 70 is retracted or extended relative to the shank 60, the blade 70 can be locked at a desired position by the engagement between the slider 80 and the engagement teeth 61. Therefore, the blade 70 can be controlled to extend for use easily, and a safety of retracting the blade 70 can be improved.

However, the engagement teeth 61 are formed on the side of the guiding groove and only form a uni-side locking effect for the slider 80, but a force applied on the blade 70 when the blade 70 sliding is uniformly distributed on two sides of the blade 70. Therefore, the engagement teeth 61 formed on only one side of the guiding groove need to have sufficient depths, such that the engagement teeth 61 can provide an appropriate locking effect. If the engagement teeth 61 have insufficient depths for locking, the locking effect for the slider 80 is weak such that the locking may be self-released easily. Furthermore, the engagement teeth 61 are exposed to an exterior environment, such that the engagement teeth 61 are aged easily under impacts of the exterior environment, and the aesthetic appeal is affected as well.

### SUMMARY OF THE INVENTION

In view of the drawbacks of the conventional utility cutter, the present invention improves the conventional utility cutter to provide a locking structure having a firm locking effect and not affected by an exterior environment.

To achieve the afore-mentioned purpose, the present invention provides a multi-locking utility cutter, cutter which has a shank, a blade, and a slider.

The shank has a guiding groove. The guiding groove has multiple first locking units formed in the guiding groove.

The blade is slidably mounted in the guiding groove and selectively covers the first locking units.

The slider is connected with the blade, is slidably mounted on the shank, and has a second locking unit selectively engaged with one of the first locking units and an elastic unit connected with the second locking unit. When the slider is slid relative to the shank, the elastic unit drives the second locking unit to be engaged with one of the first locking units.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a multi-locking utility cutter in accordance with the present invention;

FIG. 2 is an exploded perspective view of the multi-locking utility cutter in FIG. 1;

FIG. 3 is another exploded perspective view of the multi-locking utility cutter in FIG. 1;

FIG. 4 is an enlarged exploded perspective view of a slider of the multi-locking utility cutter in FIG. 1;

FIG. 5 is another enlarged exploded perspective view of a slider of the multi-locking utility cutter in FIG. 1;

FIG. 6 is an enlarged perspective view of the slider of the multi-locking utility cutter in FIG. 1;

FIG. 7 is another enlarged perspective view of the slider of the multi-locking utility cutter in FIG. 1;

FIG. 8 is a cross sectional side view of the multi-locking utility cutter in FIG. 1, showing the blade retracted;

FIG. 9 is a cross sectional side view of the multi-locking utility cutter in FIG. 1, showing the blade extended out;

FIG. 10 is an operational cross sectional side view of the multi-locking utility cutter in FIG. 1, showing the blade is about to be extended out;

FIG. 11 is an operational cross sectional side view of the multi-locking utility cutter in FIG. 1, showing the blade is about to be retracted; and

FIG. 12 is a front view of a conventional multi-locking utility cutter.

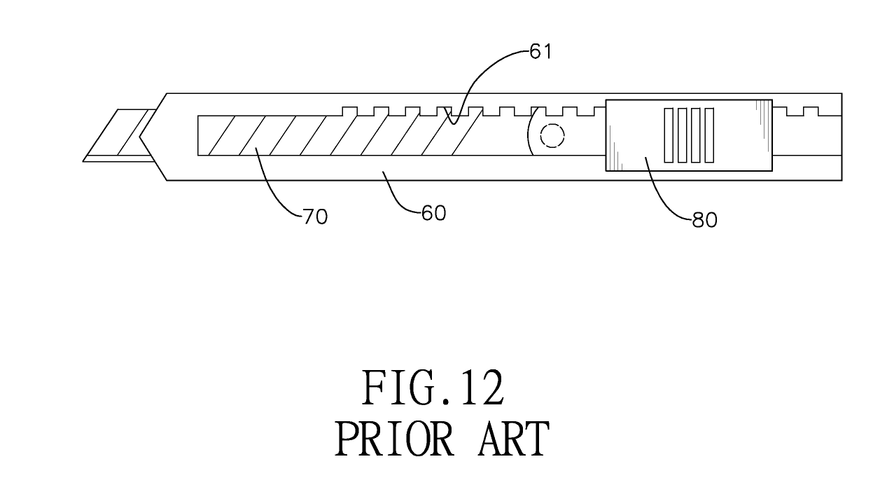

### DETAILED DESCRIPTION OF PREFERRED EMBODIMENT

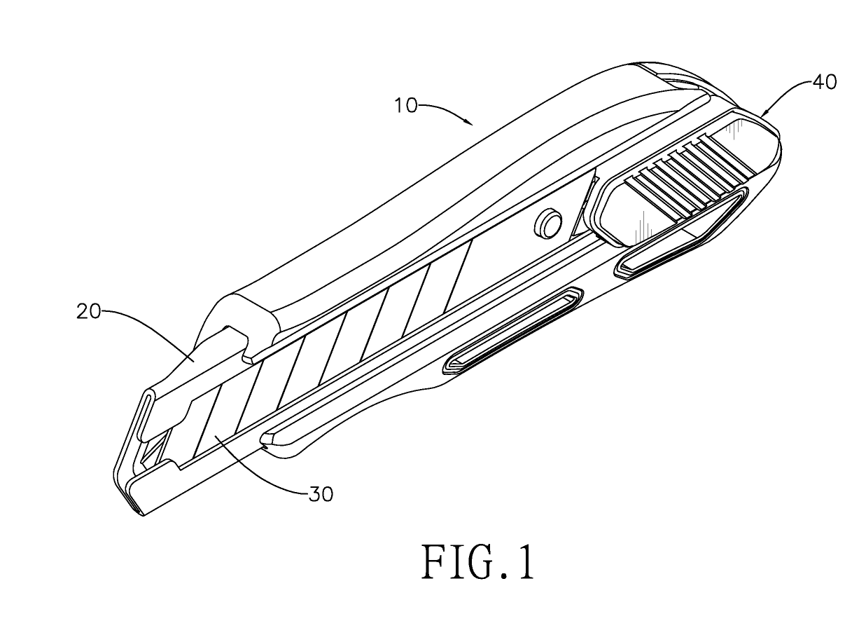

With reference to FIGS. 1 to 3, a preferred embodiment of a multi-locking utility cutter in accordance with the present invention has a shank 10, a cutter base 20, a blade 30, a slider 40, and a backup cutter holder 50.

The shank 10 has a guiding groove 11 formed in a front side of the shank 10. The guiding groove 11 has multiple first locking units 12 formed in the guiding groove 11 at intervals. The shank 10 further has a backup cutter channel 13 formed in a rear side of the shank 10. Preferably, the backup cutter channel 13 has an opening 131. The shank 10 has a button hole 132 formed in the rear side of the shank 10. The button hole 132 is adjacent to the opening 131 of the backup cutter channel 13.

The cutter base 20 is mounted in the guiding groove 11 of the shank 10. Preferably, the first locking units 12 are located at a bottom surface of the cutter base 20. The first locking units 12 may be recesses.

The blade 30 is slidably mounted in the guiding groove 11 and covers the first locking units 12. Preferably, the blade 30 is slidably mounted in the cutter base 20. The blade 30 has a blade hole 31 formed through the blade 30.

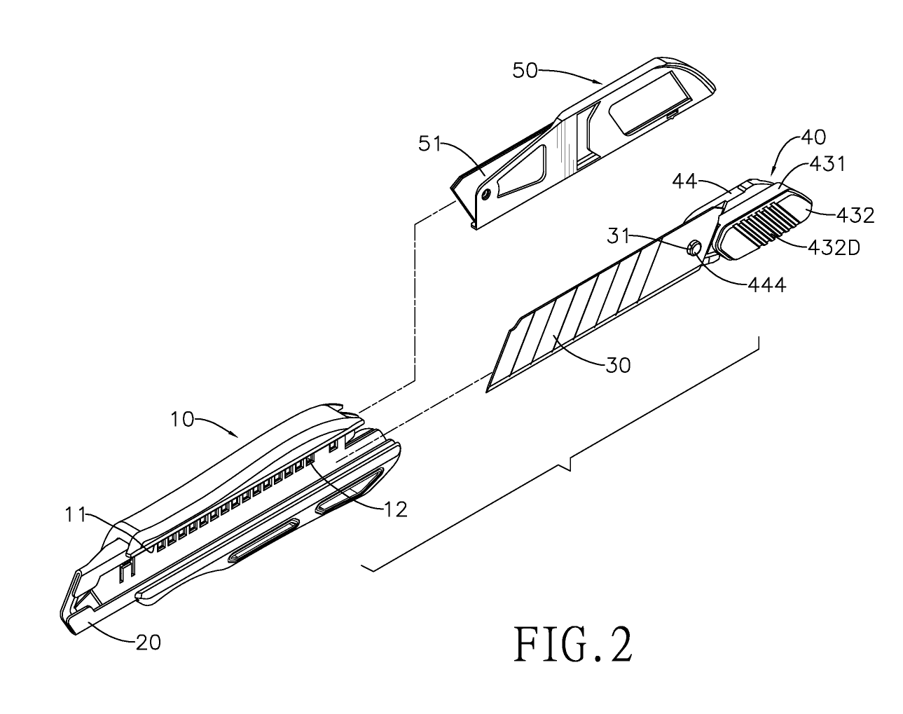

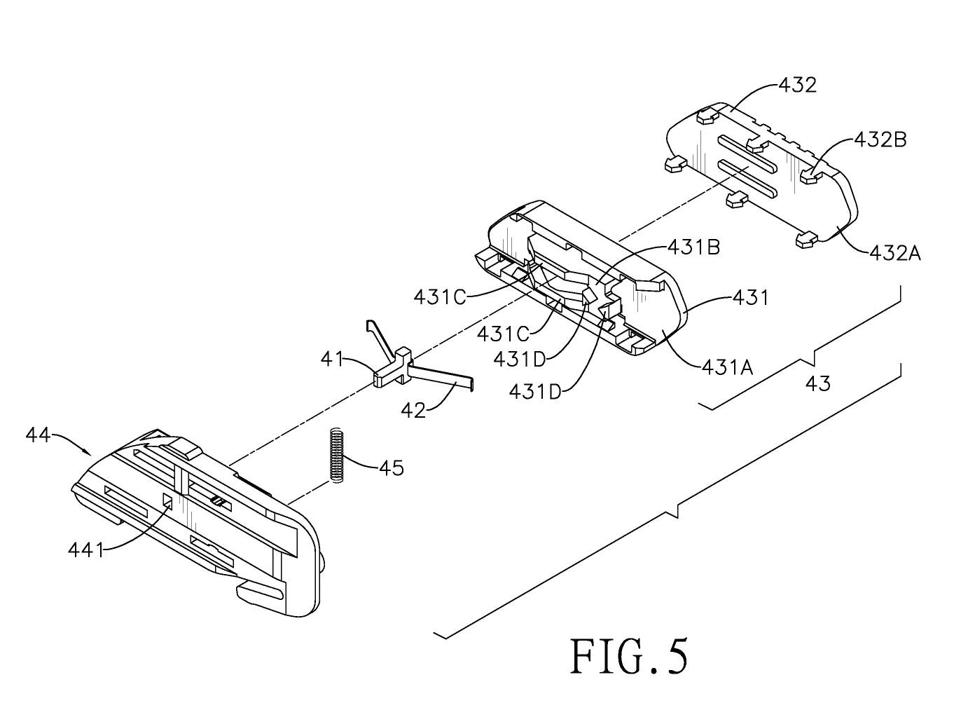

With reference to FIGS. 2, 4 and 5, the slider 40 is connected with the blade 30 and is slidably mounted in the shank 10. The slider 40 has a second locking unit 41 and an elastic unit 42. The second locking unit 41 is selectively engaged with one of the first locking units 12. The elastic unit 42 is connected with the second locking unit 41. When the slider 40 is slid relative to the shank 10, the elastic unit 42 drives the second locking unit 41 to engage with one of the first locking units 12. Preferably, the second locking unit 41 is a block. Preferably, the slider 40 has an upper sliding unit 43 and a lower sliding unit 44. The lower sliding unit 44 is connected with the blade 30. The elastic unit 42 is mounted between the upper sliding unit 43 and the lower sliding unit 44. The upper sliding unit 43 can be first slid relative to the lower sliding unit 44. Then, after the upper sliding unit 43 is slid relative to the lower sliding unit 44, the upper sliding unit 43 can drive the lower sliding unit 44 to slide relative to the shank 10. When the upper sliding unit 43 is first slid relative to the lower sliding unit 44, the elastic unit 42 drives the second locking unit 41 to be retracted relative to the lower sliding unit 44.

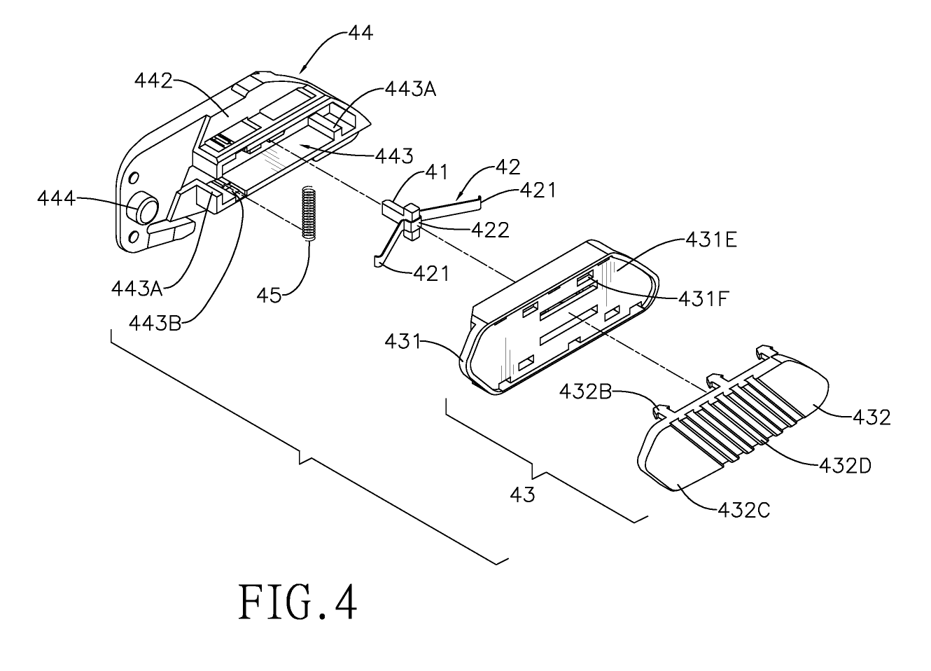

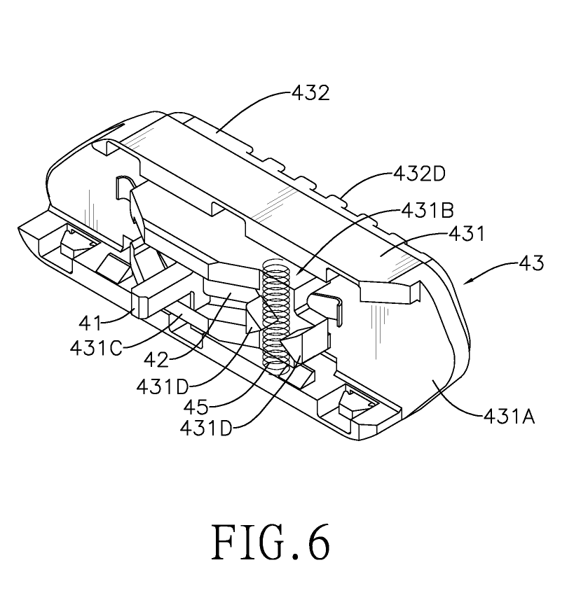

With reference to FIGS. 4 to 6, the upper sliding unit 43 has a body 431 and a cover 432. The body 431 has a limiting block 431B protruding from an inner surface 431A of the body 431. The limiting block 431B has two block walls 431C protruding from the limiting block 431B. The elastic unit 42 is mounted between the block walls 431C for restricting a position of the elastic unit 42. The limiting block 431B has two clamping portions 431D protruding from the limiting block 431B. The cover 432 is mounted on an outer surface 431E of the body 431. The body 431 has multiple fixing holes 431F formed through the body 431. The cover 432 has multiple fixing blocks 432B protruding from an inner surface 432A of the cover 432. The fixing blocks 432B are respectively inserted into and fixed in the fixing holes 431F, such that the cover 432 is fixed on the outer surface 431E of the body 431. The cover 432 has multiple ribs 432D formed on an outer surface 432C of the cover 432. The ribs 432D provide a slip-proof effect, such that a user can conveniently push the upper sliding unit 43 to move.

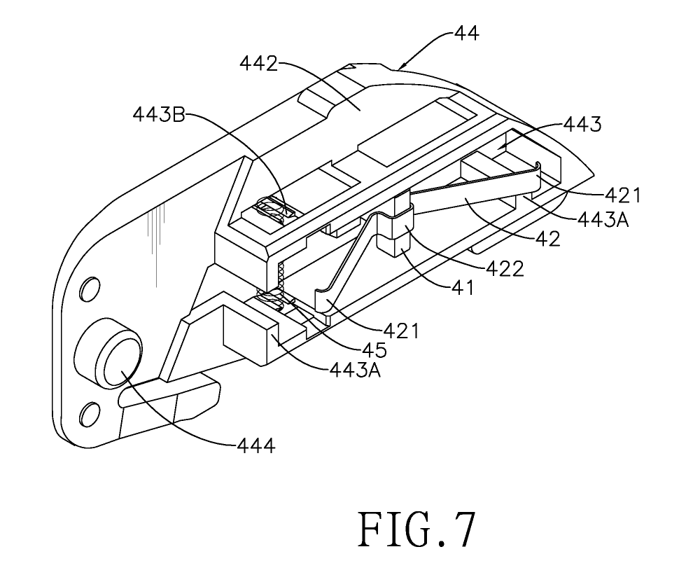

With reference to FIGS. 2, 4, 5 and 7, the lower sliding unit 44 covers the inner surface 431A of the body 431 of the upper sliding unit 43. The lower sliding unit 44 has a through hole 441. The second locking unit 41 has a first end and a second end. The first end of the second locking unit 41 is inserted into the through hole 441. The second end of the second locking unit 41 is clamped by the elastic unit 42. Preferably, the elastic unit 42 may be an elastic plate. The elastic unit 42 has two end portions 421 abutting on the body 431 of the upper sliding unit 43. The elastic unit 42 has a middle portion 422 being convex and has an accommodating recess formed in the middle portion 422. The second end of the second locking unit 41 is mounted in the accommodating recess. The lower sliding unit 44 has an accommodating space 443 formed in an inner surface 442 of the lower sliding unit 44. The accommodating space 443 has two stopping blocks 443A respectively formed on two ends of the accommodating space 443. When the upper sliding unit 43 is moved relative to the lower sliding unit 44, an end of the limiting block 431B selectively abuts one of the stopping blocks 443A, such that the upper sliding unit 43 can be stopped and cannot further move relative to the lower sliding unit 44. Furthermore, the upper sliding unit 43 drives the lower sliding unit 44 to move at the same time by the abutment between the limiting block 431B and the stopping block 443A.

The accommodating space 443 has two clamping holes 443B respectively formed through a top surface and a bottom surface of the accommodating space 443. The slider 40 further has a reset member 45. Two ends of the reset member 45 are respectively engaged in the clamping holes 443B. The reset member 45 has two sides clamped by the clamping portions 431D of the body 431 of the upper sliding unit 43. When the upper sliding unit 43 is forced to move relative to the lower sliding unit 44, the reset member 45 does not move with the upper sliding unit 43 since the reset member 45 is engaged in the clamping holes 443B, such that the reset member 45 is pushed and deformed by the clamping portions 431D and stores an elastic force. When the exterior force applied on the upper sliding unit 43 is removed, the stored elastic force of the reset member 45 pushes the upper sliding unit 43 to return to a normal position relative to the lower sliding unit 44. The lower sliding unit 44 has a bump 444 formed on an end of the lower sliding unit 44. The bump 444 is engaged in the blade hole 31 of the blade 30, such that the lower sliding unit 44 can be connected with the blade 30.

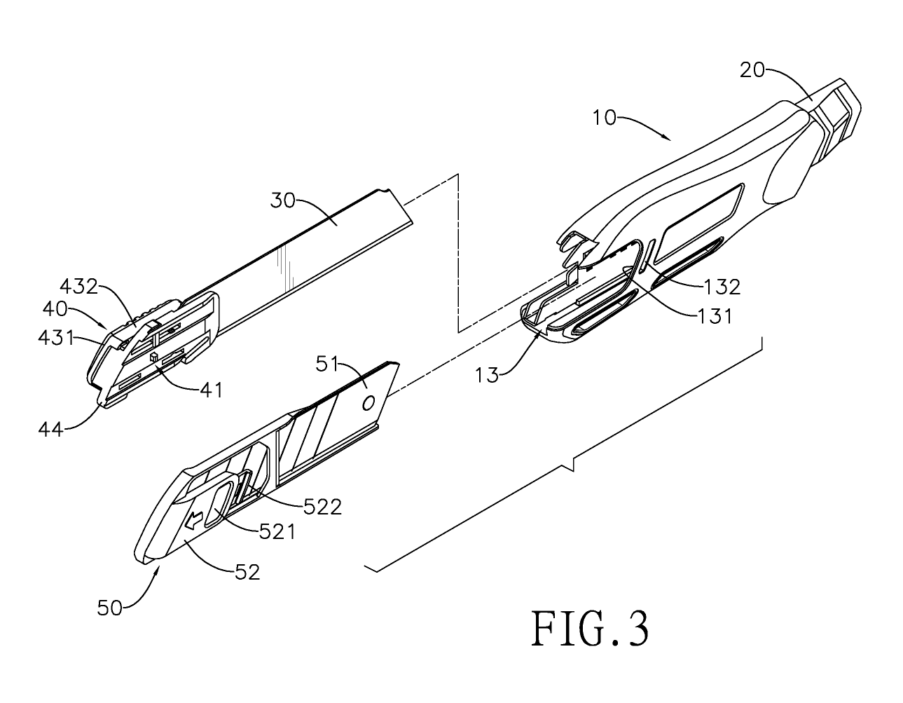

With reference to FIGS. 2 and 3, the backup cutter holder 50 is mounted in the backup cutter channel 13 of the shank 10. The backup cutter holder 50 has a backup blade 51 provided for replacing the blade 30. The backup cutter holder 50 has a pushing portion 52 formed on a side of the backup cutter holder 50. The pushing portion 52 is inserted into the opening 131 of the backup cutter channel 13. The pushing portion 52 has a recess 521 formed in the pushing portion 52 for the user to conveniently push the pushing portion 52. The pushing portion 52 has a button block 522 formed on the pushing portion 52. When the backup cutter holder 50 is inserted into the backup cutter channel 13, the button block 522 is engaged in the button hole 132 to keep the backup cutter holder 50 from inadvertently sliding out of the shank 10.

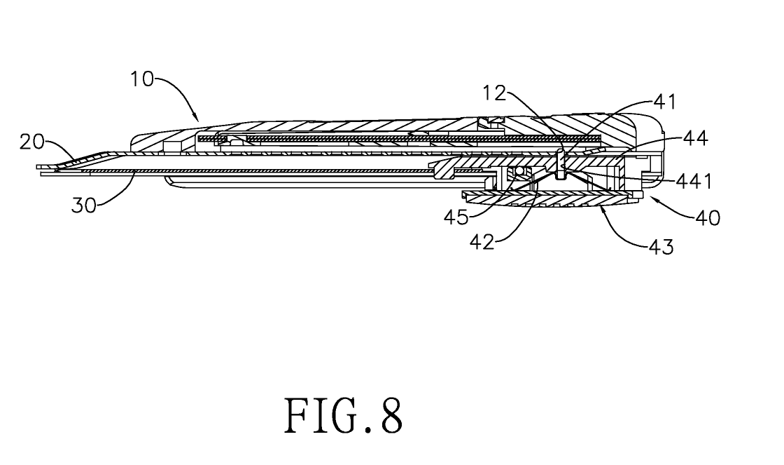

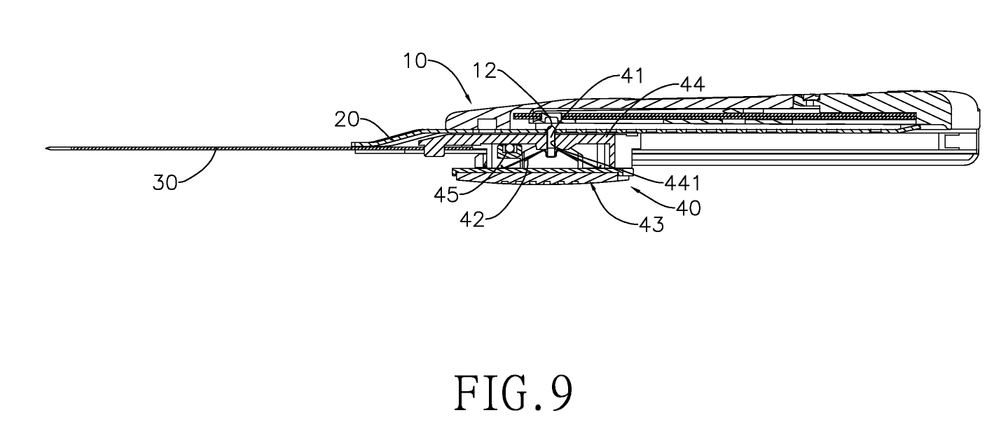

With reference to FIGS. 8 and 9, when the slider 40 is not forced, the second locking unit 41 is pushed by the elastic unit 42 to be engaged with one of the first locking units 12, such that the slider 40 cannot be slid relative to the shank 10. At the same time, the blade 30 is constrained by the slider 40 and cannot slide arbitrarily no matter how the shank 10 is disposed since the blade 30 is connected with the lower sliding unit 44. Therefore, the blade 30 can be held in the shank 10 firmly, as shown in FIG. 8. Alternatively, the blade 30 can be locked at a desired extension length relative to the shank 10 for use, as shown in FIG. 9.

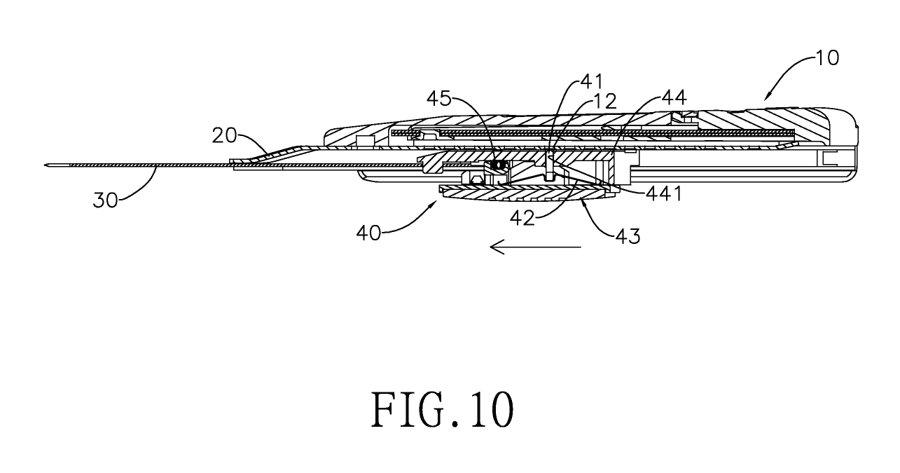

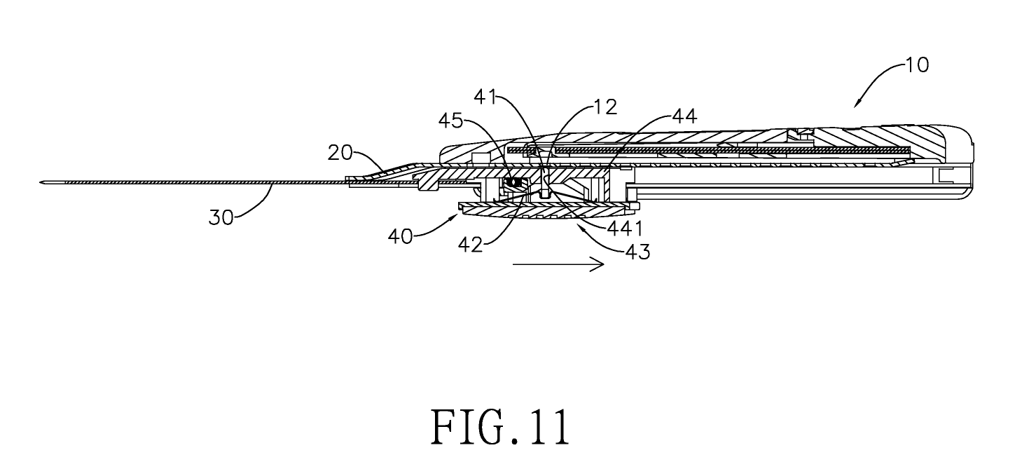

With reference to FIGS. 10 and 11, when the user wants to push the blade 30 out of the shank 10 or retract the blade 30 into the shank 10, the user has to apply force on the upper sliding unit 43. After the user applies force on the upper sliding unit 43, the upper sliding unit 43 can first move relative to the lower sliding unit 44. Then, because the first end of the second locking unit 41 is inserted into the through hole 441 of the lower sliding unit 44 and the second end of the second locking unit 41 is clamped by the elastic unit 42, the second locking unit 41 can move only along a vertical direction relative to the upper sliding unit 43 and cannot move along a lateral direction relative to the upper sliding unit 43. Therefore, when the upper sliding unit 43 moves along the lateral direction relative to the lower sliding unit 44, the second locking unit 41 is in a situation in which the second locking unit 41 cannot move along the lateral direction. As a result, only the elastic unit 42 is forced to be compressed and deformed, a clamping relationship between the elastic unit 42 and the second locking unit 41 can be maintained. At the same time, the second locking unit 41 moves along the vertical direction to disengage from the first locking unit 12, such that a locking relationship between the slider 40 and the shank 10 is released. Accordingly, the user can continuously push the slider 40 with the blade 30 to move along the lateral direction. When an external force that pushes the slider 40 is removed, the reset member 45 can drive the upper sliding unit 43 to move to the normal position relative to the lower sliding unit 44. Then, the elastic unit 42 can push the second locking unit 41 to move to the locked state as shown in FIG. 8 or in FIG. 9.

Therefore, when one of the first locking units 12 is engaged with the second locking unit 41, the slider 40 is locked. A locking position of the first locking unit 12 and the second locking unit 41 is located at the bottom surface of the cutter base 20. The cutter base 20 is inserted into the guiding groove 11 of the shank 10, and the blade 30 is slidably mounted in the guiding groove 11, so the locking force between the first locking unit 12 and the second locking unit 41 is located at a bottom side of the blade 30. When the slider 40 is locked and cannot slide, the locking force is uniformly distributed on the blade 30 and the guiding groove 11 and can be uniformly applied for the sides of the blade 30. Except under some rare condition, (for example, the blade 30 is extended out of the shank 10 for a relatively long length,) the first locking units 12 are sheltered by the blade 30 without exposure to the exterior environment, such that the first locking units 12 can be protected from damage.

From the above description, it is noted that the present invention has the following advantages:

The blade 30 covers the first locking units 12, such that the first locking units 12 are unexposed to the exterior environment under most conditions. The first locking units 12 are covered by the blade 30 under most conditions, such that the first locking units 12 can be protected properly and the probability of damage to the first locking units 12 can be decreased. The slider 40 is locked by the engagement between the second locking unit 41 and one of the first locking units 12. The locking position is located at the guiding groove 11 of the shank 10, such that when the slider 40 is locked and cannot be slid relative to the shank 10, the locking force of the slider 40 is distributed uniformly on the guiding groove 11 of the shank 10. Therefore, the locking effect of the slider 40 can be improved, such that the locking state of the slider 40 cannot slide inadvertently.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-locking utility cutter having:
a shank having a guiding groove, wherein the guiding groove has multiple first locking units formed in the guiding groove;
a blade slidably mounted in the guiding groove and selectively covering the first locking units; and
a slider connected with the blade and slidably mounted on the shank, the slider having
a second locking unit selectively engaged with one of the first locking units; and
an elastic unit connected with the second locking unit, wherein when the slider is slid relative to the shank, the elastic unit drives the second locking unit to be engaged with one of the first locking units.

2. The multi-locking utility cutter as claimed in claim 1, wherein the slider has an upper sliding unit and a lower sliding unit, wherein the elastic unit is mounted between the upper sliding unit and the lower sliding unit, wherein the upper sliding unit is slidably relative to the lower sliding unit, and the lower sliding unit is driven to slide relative to the shank by the upper sliding unit, wherein when the upper sliding unit is slid relative to the lower sliding unit, the elastic unit drives the second locking unit to retract relative to the lower sliding unit.

3. The multi-locking utility cutter as claimed in claim 2, wherein the upper sliding unit has a body, the body has a limiting block protruding from an inner surface of the body, the limiting block has two block walls protruding from the limiting block, wherein the elastic unit is mounted between the block walls, the lower sliding unit has an accommodating space formed in an inner surface of the lower sliding unit, and the accommodating space has two stopping blocks respectively formed on two ends of the accommodating space, wherein when the upper sliding unit is moved relative to the lower sliding unit, an end of the limiting block selectively abuts one of the stopping blocks.

4. The multi-locking utility cutter as claimed in claim 2, wherein the lower sliding unit has a through hole, the second locking unit has a first end and a second end, the first end of the second locking unit is inserted into the through hole, and the second end of the second locking unit is clamped by the elastic unit.

5. The multi-locking utility cutter as claimed in claim 4, wherein the elastic unit is an elastic plate, the elastic unit has two end portions abutting on the body of the upper sliding unit, the elastic unit has a middle portion being convex and has an accommodating recess formed in the middle portion, and the second end of the second locking unit is mounted in the accommodating recess.

6. The multi-locking utility cutter as claimed in claim 2, wherein the upper sliding unit has a cover mounted on an outer surface of the body.

7. The multi-locking utility cutter as claimed in claim 6, wherein the body has multiple fixing holes formed through the body, the cover has multiple fixing blocks protruding from an inner surface of the cover, wherein the fixing blocks are respectively inserted into and fixed in the fixing holes.

8. The multi-locking utility cutter as claimed in claim 6, wherein the cover of the upper sliding unit has multiple ribs formed on an outer surface of the cover.

9. The multi-locking utility cutter as claimed in claim 2, wherein the slider further has a reset member mounted between the upper sliding unit and the lower sliding unit, wherein the reset member drives the upper sliding unit to return to a normal position relative to the lower sliding unit after the upper sliding unit slides.

10. The multi-locking utility cutter as claimed in claim 9, wherein the upper sliding unit has two clamping portions, the lower sliding unit has two clamping holes, wherein two ends of the reset member are respectively engaged in the clamping holes, and two sides of the reset member are clamped by the clamping portions of the upper sliding unit.

11. The multi-locking utility cutter as claimed in claim 3, wherein the slider has a reset member, the accommodating space of the lower sliding unit has two clamping holes respectively formed through a top surface and a bottom surface of the accommodating space, the limiting block of the body of the upper sliding unit has two clamping portions protruding on the limiting block, wherein two ends of the reset member are respectively engaged with the clamping holes, and two sides of the reset member are clamped by the clamping portions of the body of the upper sliding unit.

12. The multi-locking utility cutter as claimed in claim 1 further having a cutter base mounted in the guiding groove, wherein the first locking units are formed in a bottom surface of the cutter base, and the blade is slidably mounted in the cutter base.

13. The multi-locking utility cutter as claimed in claim 11 further having a cutter base mounted in the guiding groove, wherein the first locking units are formed in a bottom surface of the cutter base, and the blade is slidably mounted in the cutter base.

14. The multi-locking utility cutter as claimed in claim 1 further having a backup cutter holder detachably mounted in the shank.

15. The multi-locking utility cutter as claimed in claim 11 further having a backup cutter holder detachably mounted in the shank.

16. The multi-locking utility cutter as claimed in claim 14, wherein the shank has a backup cutter channel formed in a rear side of the shank, wherein the backup cutter holder is detachably mounted in the backup cutter channel.

17. The multi-locking utility cutter as claimed in claim 15, wherein the shank has a backup cutter channel formed in a rear side of the shank, wherein the backup cutter holder is detachably mounted in the backup cutter channel.

18. The multi-locking utility cutter as claimed in claim 16, wherein the backup cutter channel has an opening, the shank has a button hole formed in the rear side of the shank being adjacent to the opening of the backup cutter channel, the backup cutter holder has a pushing portion formed on a side of the backup cutter holder, wherein the pushing portion is inserted into the opening of the backup cutter channel, the pushing portion has a button block, wherein when the backup cutter holder is inserted into the backup cutter channel, the button block is engaged in the button hole.

19. The multi-locking utility cutter as claimed in claim 17, wherein the backup cutter channel has an opening, the shank has a button hole formed in the rear side of the shank being adjacent to the opening of the backup cutter channel, the backup cutter holder has a pushing portion formed on a side of the backup cutter holder, wherein the pushing portion is inserted into the opening of the backup cutter channel, the pushing portion has a button block, wherein when the backup cutter holder is inserted into the backup cutter channel, the button block is engaged in the button hole.
